(19) United States
(12) Patent Application Publication
(10) Pub. No.: US 2006/0065648 A1
(43) Pub. Date: Mar. 30, 2006

(54) Method and device for removing burr by high-density energy beam

(76) Inventors: Michio Kameyama, Toyota-city (JP); Sumitomo Inomata, Toyota-city (JP); Terukazu Fukaya, Nagoya-city (JP); Eiji Kumagai, Okazaki-city (JP); Hiromichi Morita, Kariya-city (JP)

Correspondence Address: POSZ LAW GROUP, PLC, 12040 SOUTH LAKES DRIVE, SUITE 101, RESTON, VA, 20191, US

(21) Appl. No.: 11/159,263

(22) Filed: Jun. 23, 2005

(30) Foreign Application Priority Data
Sep. 29, 2004 (JP) 2004-284581

(51) Int. Cl. B23K 26/38

(52) U.S. Cl. 219/121.71; 219/121.69

(57) ABSTRACT

A burr removing device for removing a burr, which is formed at a connection between a first hole and a second hole that are angled relative to each other inside a workpiece. According to the burr removing device, a generated high-density energy beam is converged by a converging lens, which is located outside of the first and second holes of the workpiece. Then, the converged high-density energy beam is reflected toward the burr by a one reflecting mirror, which is located in one of the first and second holes.

### CROSS REFERENCE TO RELATED APPLICATION

This application is based on and incorporates herein by reference Japanese Patent Application No. 2004-284581 filed on Sep. 29, 2004.

### BACKGROUND OF THE INVENTION

1. Field of the Invention

The present invention relates to a technique for removing a burr, which is developed when a cutting is operated on a workpiece. Specifically, this invention relates to a technique for removing a burr, which is developed at a connection between a first hole and a second hole that are angled relative to each other inside the workpiece.

2. Description of Related Art

Parts, such as an oil pressure pump and a fuel pump, have intricate small holes (a diameter of about 1 to 10 mm) to supply oil and fuel. Most of the parts have a connection between holes that are angled relative to each other, and have some difficulties.

The first difficulty will be described. A burr is developed at every connection between holes, which are mainly made by a cutting process. The burr not only obstructs oil and fuel supply, but also has a risk to stop a product function when the burr comes off and clogs a valve and the like.

Therefore, the burr is polished by a brush or is removed by an electrolytic burr removing device. In a case when the burr is polished by the brush, the burr possibly remains inside of the hole if the burr falls to a surface of the hole. Also, in the case of electrolytic removal, an equipment is expensive and various kinds of electrodes need to be produced according to conditions. When the electrodes are worn out and need to be reproduced, the reproduction of the electrodes costs high. Therefore, the high reproduction cost is also a disadvantage. Recently, it has become difficult to treat waste liquid electrolyte because of an environmental concern. Therefore, a burr removal method is required, which is highly reliable, inexpensive and has a small environmental impact.

A second difficulty will be described. Recently, the pressure inside parts, such as a pump, is getting higher and higher. Therefore, a corner of a connection between two holes is required to be rounded to relieve a stress. It is easy to perform a machining operation of the holes if the corner is exposed to outside. However, it is difficult to operate machining inside a small and long hole of a pump part and the like.

As a countermeasure for above described difficulties, a burr removing method by a laser beam is disclosed in Japanese Unexamined Patent Publication No. 2000-317660, wherein the burr removing method does not require any electrodes and still performs quick removal.

According to the method described in the Japanese Unexamined Patent Publication No. 2000-317660, it is described that a burr at the connection between two holes is possibly removed. However, Japanese Unexamined Patent Publication No. 2000-317660 does not disclose a specific method for removing a burr inside a hole. In Japanese Unexamined Patent Publication No. 2000-317660, a laser with a galvanometer scanner irradiates a workpiece with a laser beam from outside, while an articulated robot holds the workpice. However, this method has difficulty in removing the burr inside the hole, although the method effectively removes the burr exposed to an outside. Also, Japanese Unexamined Patent Publication No. 2000-317660 describes a method for removing the burr by using an optical fiber, which is held by the articulated robot. However, it is difficult to accurately position a fine optical fiber at the connection of holes. The method in Japanese Patent Unexamined Publication No. 2000-317660 may be applied to a large hole with a diameter of a several tens of millimeters, if estimating an applicable range of the burr removal inside a hole according to the description in the above described Japanese Patent Unexamined Publication. Thus, it is difficult to remove the burr inside a small hole, which has a diameter of a few millimeters.

### SUMMARY OF THE INVENTION

The present invention addresses the above disadvantages. Thus, it is an objective of the present invention to provide a method and a device for effectively removing a burr, which is developed at a connection of holes inside a workpiece, by a high-density energy beam.

To achieve the objective of the present invention, there is provided a method for removing a burr, which is formed at a connection between a first hole and a second hole that are angled relative to each other inside a workpiece. According to the method, a high-density energy beam is generated. The high-density energy beam is converged by a converging lens, which is located outside of the first and second holes of the workpiece. Then, the converged high-density energy beam is reflected toward the burr by at least one reflecting mirror, which is located in one of the first and second holes.

To achieve the objective of the present invention, there is also provided a burr removing device for removing a burr, which is formed at a connection between a first hole and a second hole that are angled relative to each other inside a workpiece. The burr removing device includes a high-density energy beam generator, a tubular housing, a converging lens, and at least one reflecting mirror. The high-density energy beam generator generates a high-density energy beam. The tubular housing is located in one of the first and second holes at time of operation. The converging lens is located outside of the workpiece for converging the high-density energy beam generated by the high-density energy beam generator. The at least one reflecting mirror is located inside the tubular housing for reflecting the high-density energy beam, which is converged by the converging lens, toward the burr.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view of a burr removing device for removing a burr by a high-density energy beam according to a first embodiment of the present invention;

FIG. 2 is a cross-sectional view of a workpiece;

FIG. 3 is a view of the burr removing device;

FIG. 4 is a view of a main part of the burr removing device;

FIGS. 5A and 5B are cross-sectional views of an irradiated spot by a laser beam;

FIGS. 6A and 6B are cross-sectional views of the irradiated spot by a laser beam;

FIG. 7 is a cross-sectional view of the burr removing device and the workpiece, when a forcible drawing is applied;

FIG. 8 is a cross-sectional view of the burr removing device and the workpiece, when a forcible drawing is not applied;

FIGS. 9A and 9B are cross-sectional views of adjustable focal point lenses;

FIG. 10 is a view of a main part of an optical unit;

FIG. 11 is a view of a main part of an optical unit;

FIG. 12 is a schematic view of a burr removing device with a high-density energy beam according to a second embodiment;

FIG. 13 is a schematic view of a burr removing device with a high-density energy beam according to the second embodiment;

FIG. 14 is a view of a main part of the burr removing device;

FIG. 15 is a schematic view taken along line XV-XV in FIG. 14;

FIG. 16 is a cross-sectional view of a detached optical unit;

FIG. 17 is a view of a main part of the burr removing device;

FIG. 18 is a view of a main part of the burr removing device; and

FIG. 19 is a cross-sectional view of a detached optical unit.

### DETAILED DESCRIPTION OF THE INVENTION

### First Embodiment

A first embodiment of the present invention will be described with reference to the accompanying drawings.

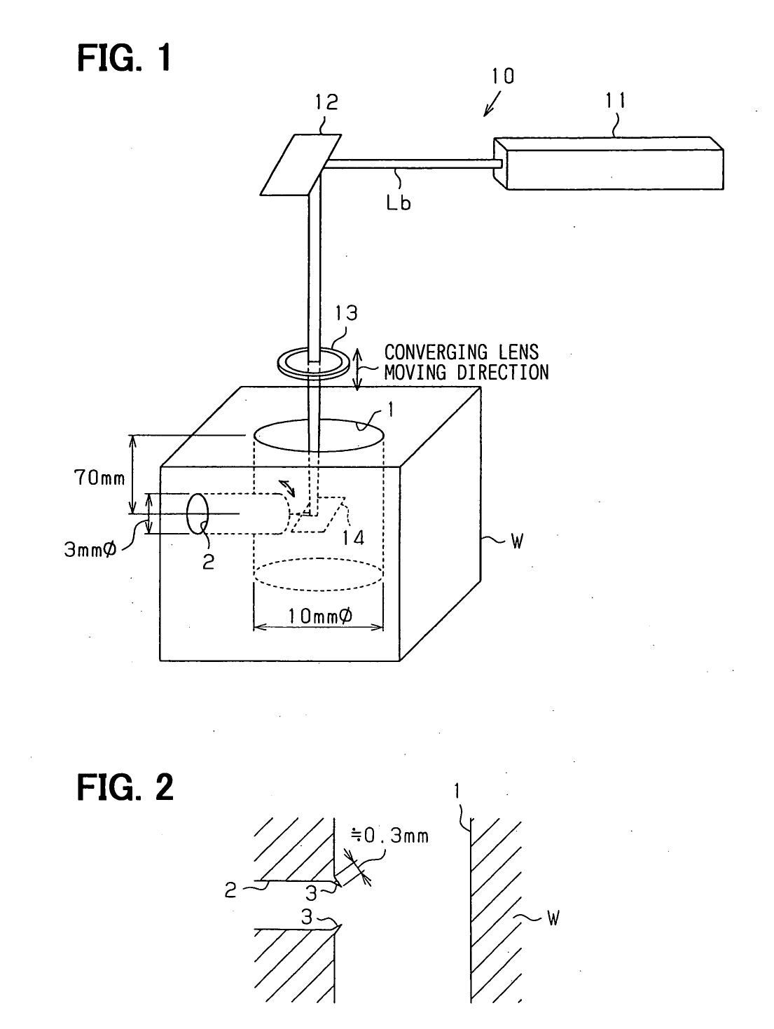

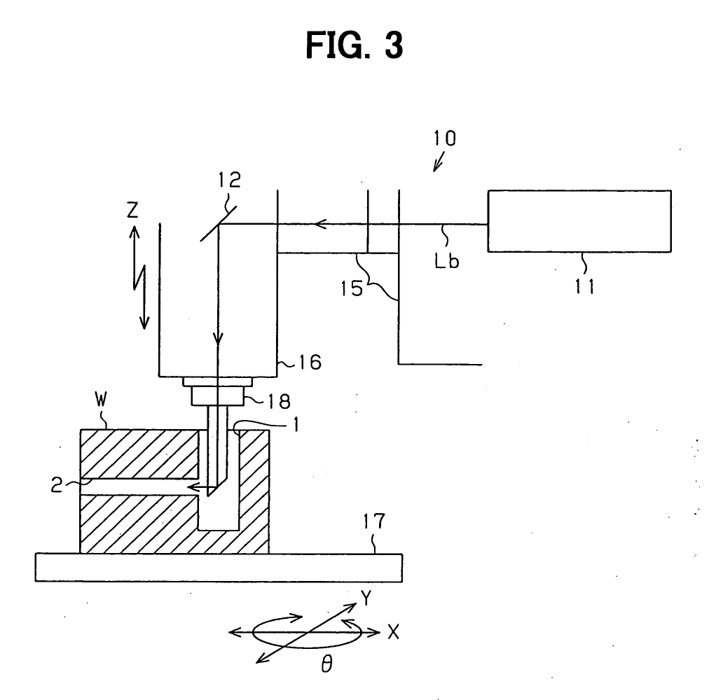

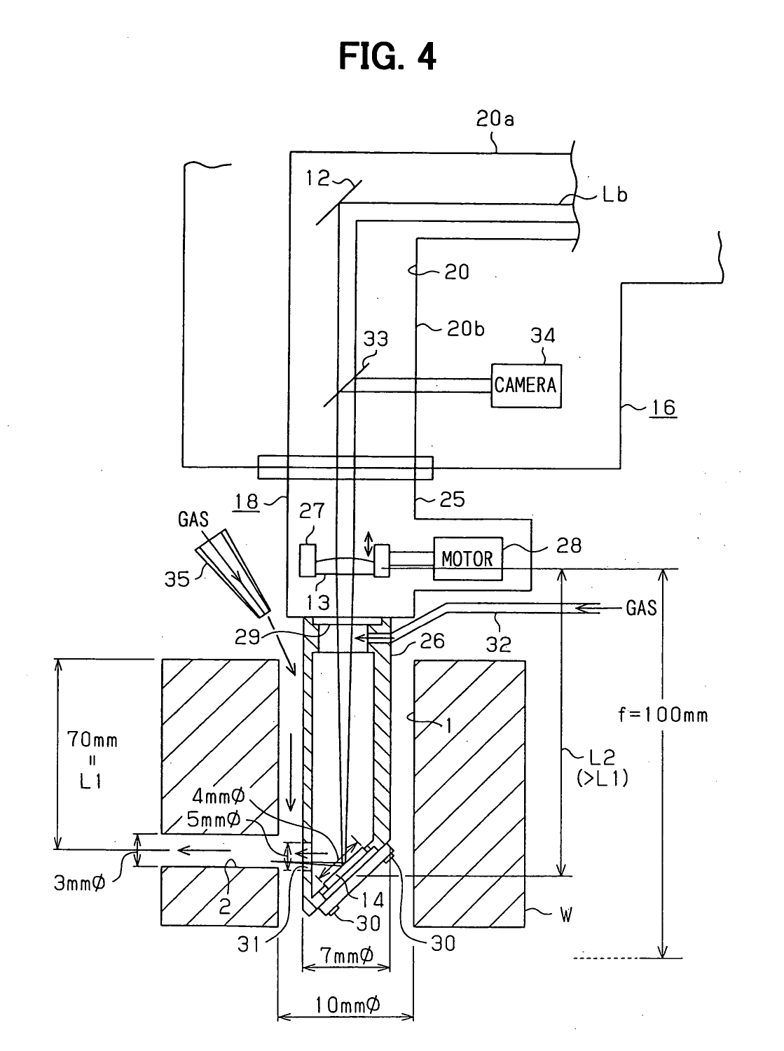

FIG. 1 is a schematic view showing a burr removing device 10 for removing a burr by a high-density energy beam Lb, according to the first embodiment of the present invention. FIG. 2 is a cross-sectional view of a workpiece W. FIG. 3 is a view of the burr removing device 10. FIG. 4 is a view of a main part of the burr removing device 10. A laser beam is used as the high-density energy beam Lb.

As shown in FIG. 1, the workpiece W is a housing block for a vehicle part (e.g., a fuel injection pump) and is made of aluminum. A connection between a hole 1 and a hole 2, which are angled relative to each other, is formed inside the workpiece W. The hole 1 is formed to extend longitudinally (vertically) from a top of the workpiece W, as shown in FIG. 1, and an axial length of the hole 1 is predetermined. The hole 2 is formed to extend laterally (horizontally) from the sidewall of the workpiece W, as shown in FIG. 1, and connects with the hole 1 (specifically, intersecting at a right angle). A diameter of the hole 1 is 10 mm, and a diameter of the hole 2 is 3 mm. The hole 2 intersects with the hole 1 at the right angle. As shown in FIG. 2, a burr 3 with a projecting length of 0.3 mm is developed at the connection between the hole 1 and the hole 2 in a cutting process of the holes 1, 2.

Although FIG. 1 schematically shows the holes of the workpiece W, the actual holes of the workpiece W are more complicated.

With reference to FIG. 1, the burr removing device 10 includes a laser beam generator 11, a mirror 12, a converging lens 13 and a reflecting mirror 14. The laser beam generator 11 generates the high-density energy beam. The reflecting mirror 14 is located inside the hole 1 of the workpiece W. Other parts 11, 12 and 13 are located outside the hole 1 of the workpiece W. A laser beam Lb, which is outputted (generated) by the laser beam generator 11, travels through the mirror 12, the converging lens 13 and the reflecting mirror 14. Then, the laser beam Lb is applied to the burr 3 (shown in FIG. 3) at the connection between the hole 1 and the hole 2 of the workpiece W. An optical path (optical system) includes the laser beam generator 11, the mirror 12, the converging lens 13 and the reflecting mirror 14. In this optical path, the laser beam Lb, which is generated by the laser beam generator 11, is converged by the converging lens 13 that is located outside the hole 1 and the hole 2 of the workpiece W. Then, the laser beam Lb travels downward inside the hole 1 of the workpiece W, as shown in FIG. 3. The laser beam Lb is reflected in the horizontal direction by the reflecting mirror 14. Thus, the laser beam Lb is applied to the burr 3 intensively. By applying the laser beam Lb toward the burr 3, the burr 3 is removed. An optical axis of the laser beam Lb that has passed through the conversing lens 13 is the same as a longitudinal axis of the hole 1, which receives the reflecting mirror 14.

The details of the burr removing device 10 will be described.

As shown in FIG. 3, the laser beam generator 10 generates a YAG laser beam with a wave length of 1.064 μm. The burr removing device 10 includes a laser beam generator support 15, a vertical positioning member 16, a table 17 and an optical unit 18. The laser beam generator support 15 holds the laser beam generator 11 and the like. The table 17 holds the workpiece W. The optical unit 18 is attached to the vertical positioning member 16. The vertical positioning member 16 is located above the table 17. The laser beam generator support 15 is located at the side of the vertical positioning member 16. The laser beam Lb is generated by the laser beam generator 11, which is located inside the laser beam generator support 15. The laser beam Lb travels downwards in the drawing after being reflected by the mirror 12, which is located inside the vertical positioning member 16. The vertical positioning member 16 moves vertically (along Z-axis direction). The table 17 moves along X-axis, Y-axis and θ direction, and θ indicates a rotational direction. The workpiece W, in which the hole 1 and the hole 2 are formed, is fixed on the table 17. Thus, the workpiece W moves along X-axis, Y-axis and θ direction, in conjunction with the table 17 movement.

The vertical positioning member 16 and the optical unit 18 will be described with reference to FIG. 4.

The vertical positioning member 16 has a laser beam passage 20. The mirror 12 is located at the corner of the connection between a horizontal part 20a and a vertical part 20b of the laser beam passage 20. The optical unit 18 is located below the vertical positioning member 16. The optical unit 18 is equipped with a lens housing 25 in an upper part of the optical unit 18 and a tubular housing 26 in a lower part of the optical unit 18. The tubular housing 26 is inserted into the hole 1. The vertical part 20b of the laser beam passage 20 inside the vertical positioning member 16 is communicated with the lens housing 25 of the optical unit 18. The converging lens 13 is located inside the lens housing 25 of the optical unit 18. The converging lens 13 has a focal length f of 100 mm. The converging lens 13 is held by a vertical sliding mechanism 27 and moves in the vertical direction in the drawing (along the optical axis of the incident beam). The vertical sliding mechanism 27 serves a beam diameter adjusting mechanism that is installed in the burr removing device 10. Thus, the converging lens 13 is held by the vertical sliding mechanism 27 and moves toward or away from the reflecting mirror 14 along the optical axis of the laser beam Lb. A motor 28 is connected to the vertical sliding mechanism 27. The motor 28 moves the converging lens 13 in the vertical direction in the drawing. A beam diameter of the laser beam Lb at an irradiated spot is adjusted by moving the converging lens 13.

The tubular housing 26 is a straight tube that stands vertically and has a closed bottom. The tubular housing 26 has an outer diameter of 7 mm and is inserted to the hole 1, which has a diameter of 10 mm. The tubular housing 26 extends from outside of the workpiece W into the inside of the hole 1. The tubular housing 26 and the lens housing 25 are connected and held together so that the laser beam Lb is introduced from the converging lens 13 to the tubular housing 26. There is a protective glass 29 between the tubular housing 26 and the lens housing 25. The protective glass 29 separates the inside of the tubular housing 26 from the inside of the lens housing 25.

The bottom inner surface of the tubular housing 26 is slanted and the reflecting mirror 14 is attached to the slanted surface. The reflecting mirror 14 is made of copper, and the copper surface is finished to a mirror by ultraprecision cutting. The laser beam Lb that passes inside the tubular housing 26 is reflected by the reflecting mirror 14 and travels toward the burr 3. The angle of the reflecting mirror 14 is adjusted by adjusting screws 30. The reflecting mirror 14 is adjusted and fixed by the adjusting screws 30 so that vertically applied laser beam Lb is reflected by the degree of 90° toward a horizontal direction. An outer diameter of the reflecting mirror 14 is 4 mm, which is smaller than an inner diameter of the hole 1. A beam outlet (gas outlet) 31 is formed at the lower part of the tubular housing 26. The laser beam Lb, which is reflected by the reflecting mirror 14, is outputted from the beam outlet 31 of the tubular housing 26 toward the burr 3. The beam outlet 31 has a diameter of 5 mm.

A gas inlet tube 32, which serves as a gas supplier, is connected to the upper part of the tubular housing 26. Gas is supplied inside the tubular housing 26 through the gas inlet tube 32. Air of 0.6 MPa is used for the gas. The air, which is supplied inside the tubular housing 26, is discharged out of the tubular housing 26 through the beam outlet 31, along the reflecting surface of the reflecting mirror 14. The air, which is supplied inside the tubular housing 26, does not travel toward the converging lens 13, because of the protecting glass 29. The protecting glass can be made of any material(s), as long as the material(s) has sufficient transparency to avoid its possible interference with the burr removing operation. A type and pressure of the gas (e.g., air in this case) are determined so that the gas, which generates a gas flow that passes by the reflecting surface of the reflecting mirror 14, prevents a melt from adhering to the reflecting mirror 14 while applying the laser beam Lb as described later.

A beam splitter 33 is located at some midpoint of the optical path of the laser beam Lb, specifically, at the vertical part 20b of the laser passage 20 (between the mirror 12 and the converging mirror 13) along the optical axis of the laser beam Lb. Thus, it is possible to monitor an interior of the hole 1 and the hole 2 through a monitor optical path (monitor optical system), which is branched off from the optical path. In the monitor optical path, which is branched off by the beam splitter 33, a camera 34, which serves as an image capturing device for monitoring the interior of the holes, is located outside the laser passage 20. The camera 34 captures an image of a burr removing part through the beam splitter 33, the converging lens 13 and the reflecting mirror 14. Thus, an adjustment of a burr removing position and an adjustment of the beam diameter by moving the converging lens 13 are performed while observing the burr removing part through the camera 34.

The optical unit 18 is inserted in an opening of the hole 1 at topside of the workpiece W. A gas supply nozzle 35, which serves as another gas supplier, is set up near a part where the optical unit 18 is inserted to the hole 1. The gas supply nozzle 35 supplies gas to the inner space between an inner wall of the hole 1 and the outer surface of the tubular housing 26. Air of 0.5. MPa is used for the gas. The gas is supplied by the nozzle 35 through the opening of the hole 1, which receives the tubular housing 26. The gas passes between the inner wall of the hole 1 and the outer surface of the tubular housing 26. Then the gas passes by the burr 3 at the connection between the hole 1 and the hole 2, and is discharged from an opening of the hole 2 (the opening on an outer surface of the workpiece W).

As described above, the burr removing device 10 has the gas supplier 35, which supplies the gas to the inner space between the inner wall of the hole 1 and the outer surface of the tubular housing 26 through the opening of the hole 1, which receives the tubular housing 26. Then, the gas passes by the burr 3 at the connection between the holes 1 and 2.

At this time, a pressure of the gas, which is discharged from the beam outlet 31 of the tubular housing 26, is lower than a pressure of the gas supplied by the gas supply nozzle 35 at the opening of the hole 1 of the workpiece W. Thus, the gas from the gas supply nozzle 35 is prevented from coming inside the tubular housing 26 through the beam outlet 31 of the tubular housing 26.

A burr removing method, which is used in an operation of the burr removing device 10, will be described.

The hole 1 and the hole 2 are formed to intersect with each other inside the workpiece W in the cutting process. The workpiece W is set (fixed) on the table 17 as shown in FIG. 3. The table 17, which has the moving mechanism for moving in the X-axis, Y-axis and θ direction, moves and rotates the workpiece W. The vertical positioning member 16, which has the moving mechanism for moving in the vertical direction, moves the optical unit 18 in the vertical direction (along Z-axis). The burr 3 is targeted through the movements and rotations of the workpiece W and the optical unit 18. Then, the laser beam is applied to the burr 3 at the connection between the hole 1 and the hole 2 inside the workpiece W to remove the burr 3. At the outside of the hole 1 and the hole 2, which are formed inside the workpiece W, the laser beam Lb is converged by the converging lens 13. The laser beam Lb is guided into the hole 1. The laser beam Lb is reflected by the reflecting mirror 14 in the hole 2 and is guided to the burr 3. The burr 3 is developed at an opening of the hole 2 at the connection between the hole 1 and the hole 2. Specifically, in the outside of the hole 1 and the hole 2, which are formed inside the workpiece W, the laser beam Lb is converged by the converging lens 13. The laser beam Lb is guided into the hole 1, which is a bigger one of the intersecting holes 1 and 2. The laser beam Lb is reflected by the reflecting mirror 14, which is located in the hole 1, and is guided to the burr 3. The burr 3 is developed at the opening of the hole 2 at the connection, and the hole 2 is a smaller one of the intersecting holes 1 and 2.

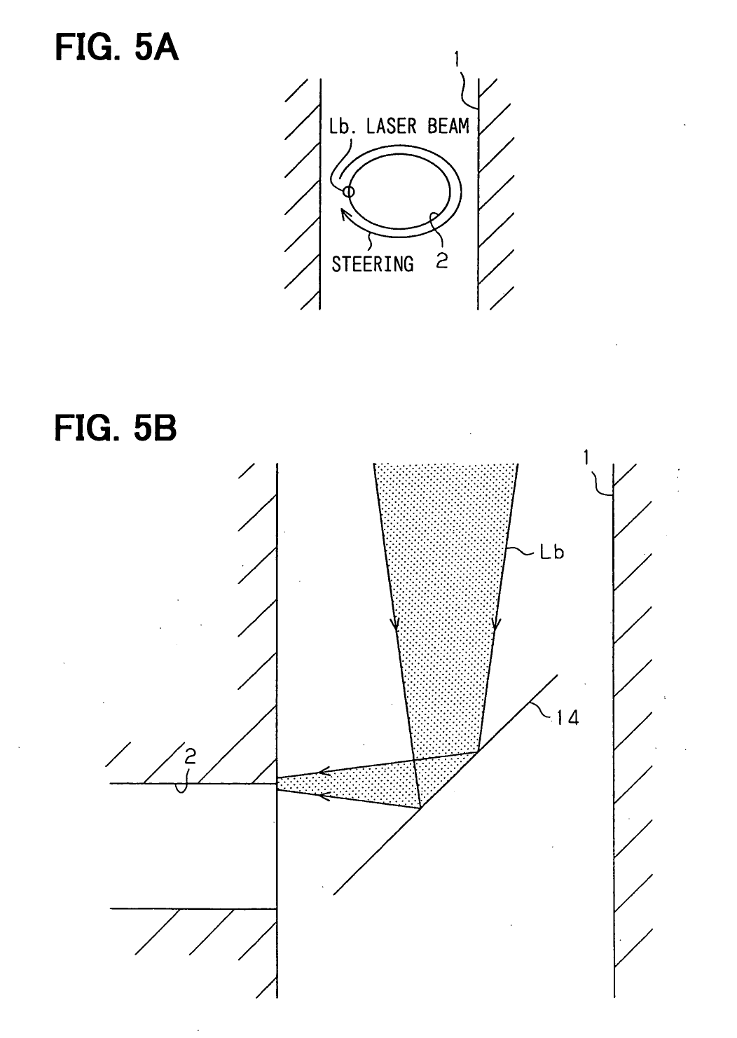

At the time applying the laser beam Lb to the burr 3, the laser beam Lb is steered or shifted toward the burr 3, which is developed at an edge of the connection between the hole 1 and the hole 2, as shown in FIGS. 5A and 5B. The steering of the laser beam Lb is performed by the vertical movement of the optical unit 18 and by the horizontal movement of the table 17 (workpiece W). The vertical positioning member 16 has the moving mechanism for moving in the vertical direction. The table 17 has the moving mechanism for moving in the X-axis, Y-axis and θ directions in the drawing. The positioning of the laser beam Lb at the time steering of the laser beam Lb is determined by a preprogrammed function (NC function). The burr is removed by the laser beam Lb under predetermined conditions, where an output is 100 W, a frequency of 50 Hz and a feeding speed is 300 mm/min. Thus, at the time a minute burr needs to be removed, the laser beam LB is steered and applied to a burr on the edge of the connection between the holes 1 and 2 (a contour of the hole 2). Also at the time a corner of the connection between the holes 1 and 2 needs to be rounded after the burr at the corner is removed, the laser beam LB is steered and applied to the corner (a contour of the hole 2).

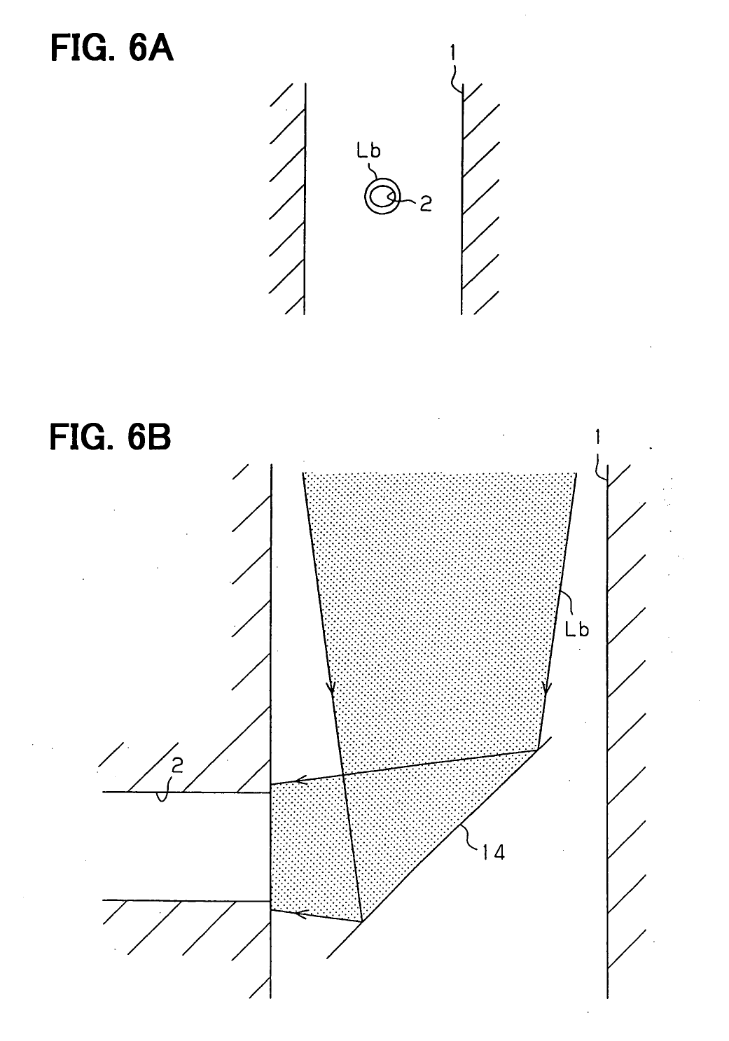

When the hole 2 is small or the burr needs to be removed quickly without a fine surface finish nor accuracy, the diameter of the laser beam Lb is made larger than a diameter of the hole 2 as shown in FIGS. 6A and 6B through adjusting a vertical position of the converging lens 13. Then, the laser beam Lb is applied to the burr 3. That is, the laser beam Lb is set such that the diameter of the laser beam LB is large enough to irradiate the whole burr on the edge of the connection between the hole 1 and the hole 2 (the contour of the holes).

Thus, in the method for removing the burr 3 at the connection between the hole 1 and the hole 2 inside the workpiece W by applying the laser beam Lb, which serves as the high-density energy beam, the laser beam Lb is converged outside of the hole 1 and the hole 2 that are formed inside the workpiece W. The laser beam Lb is guided into the first hole 1 and is reflected by the reflecting mirror 14, which is located inside the first hole 1, toward the burr 3.

In order to effectively guide the laser beam Lb into the small hole, the optical path needs to be inserted into the hole 1. Also, the inserted optical path, which is inserted, is desirable to be a fixed optical path that uses the reflecting mirror 14, so that the fixed optical path guides the beam properly inside the small hole. A diameter of the reflecting mirror is acceptable if the diameter of the reflecting mirror is at least as big as a diameter of an irradiated spot. Thus, it is possible that the diameter of the reflecting mirror is reduced to fit in the diameter of the hole 1, which receives the fixed optical path. A diameter of the laser beam supplied by the laser beam generator 11 is usually larger than the diameter of the hole 1. The diameter of the laser beam is also made larger than the diameter of the hole 1 by an expander. Thus, the converging lens 13, which ultimately converges the laser beam Lb to a converged laser beam for the burr removing process, has a diameter of a few tens of millimeters. Thus, the converging lens 13 needs to be located outside the hole 1 of the workpiece W for removing the burr 3 inside a small hole. Likewise, it is possible to remove the burr 3 formed at the connection between the hole 1 and the hole 2 that are angled relative to each other inside a workpiece W.

In this case, as shown in FIG. 4, a distance L2 between the converging lens 13 and the reflecting lens 14 is longer than a distance L1 between the inlet of the hole 1, which receives the tubular housing 26, and the connection of the hole 1 and the hole 2. Thus, the reflecting mirror 14 of the optical unit 18 is positioned to apply the laser beam LB to the burr 3 properly. Therefore, the burr 3 is effectively removed.

The beam diameter at the irradiated spot, which is irradiated with the laser beam Lb, (a focused spot diameter of the laser beam Lb, which is applied to the burr), is changed (adjusted) by changing the distance L2 between the converging lens 13 and the reflecting mirror 14 through use of the sliding mechanism 27, which serves as the beam diameter adjusting mechanism, and the motor 28. Here, the tubular housing 26 (the reflecting mirror 14) of the optical unit 18 is moved in a radial direction (in the horizontal direction in FIG. 4) inside the hole 1 in order to adjust the focused spot diameter of the laser beam Lb according to the surrounding conditions of the burr to be removed. However, the adjusting of the focused spot diameter is difficult, because a movable range is very limited when the hole 1 is small. In contrast, in the present embodiment, the focused spot diameter of the laser beam Lb is adjusted easily by adjusting the distance between the converging lens 13 and the reflecting mirror 14 in the optical unit 18.

For this adjustment, the camera 34 and the beam splitter 33, which is located between the laser beam generator 11 and the optical unit 18, are used. A location of the converging lens 13 (the diameter of the beam) is optimized while checking the conditions at the burr removing part through the image captured by the camera 34.

The adjustment is alternatively performed by a manual operation, instead of the motor operation. However, the motor 28 operation outperforms the manual operation.

A melt and sublimated material adhere to surroundings of the irradiated part at the time the laser beam Lb is applied to the burr 3 inside the hole 1 and the hole 2 while removing the burr 3. In other words, the melt and sublimated material hardens at a different location from a part where burr is removed. It is not desirable that the melt material adheres to the inside of the hole of the workpiece W because an additional burr removing process is required. Thus, the gas is supplied inside the hole 1 from the gas supply nozzle 35 while removing the burr 3 by applying the laser beam Lb to the burr 3. Then, the gas passes by the burr 3. Then, the gas discharges from the opening of the hole 2 after passing through the hole 1 and the hole 2. Therefore, a deposit is difficult to form inside the hole 1 and the hole 2 (the melt material is prevented from adhering to the inside the hole 1 and the hole 2 of the workpiece W.)

Then, conditions of the deposit, which forms while removing the burr, and a burr removed part are evaluated by the monitor mechanism (the beam splitter 33 and the camera 34).

A melt and sublimated material adhere not only to the workpiece W, but to the reflecting mirror 14 of the optical unit 18 while applying the laser beam. It becomes difficult to apply the laser beam Lb to the burr removing part appropriately and certainly when the deposit adheres to the reflecting mirror 14. This problem becomes more serious when a space between the tubular housing 26 and the inner wall of the hole 1 becomes smaller due to the smaller hole 1. Thus, this is a big problem when the tubular housing 26 of the optical unit 18 is inserted into the hole 1 during an operation.

Therefore, when the burr 3 is removed by applying the laser beam Lb, the gas is supplied into the hole 1, specifically into the tubular housing 26 of the optical unit 18. Then the gas passes by a reflecting surface of the reflecting mirror 14 and discharges from the beam outlet 31. Then, the deposit is prevented from adhering to the reflecting mirror 14.

The above embodiment of the present invention can be modified as follows.

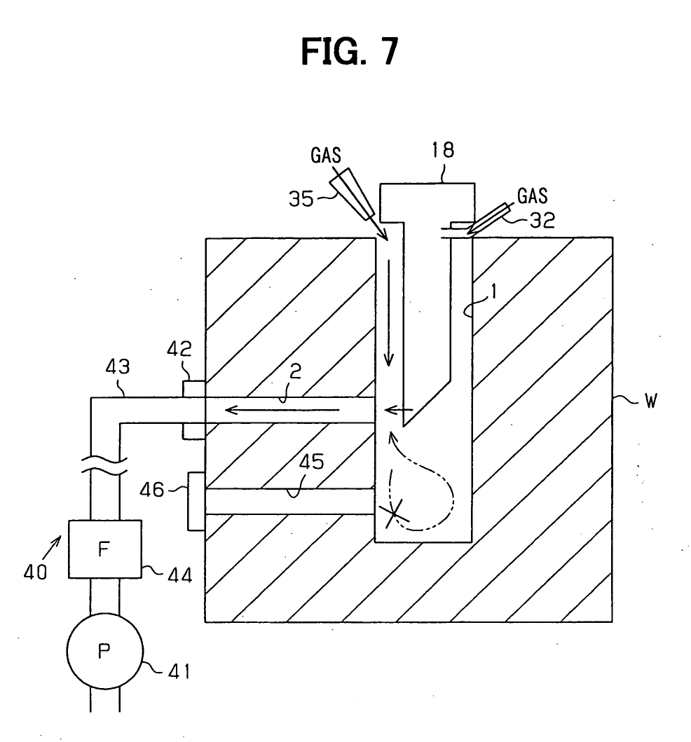

According to FIG. 7, when the gas is supplied to the hole 1 and the gas is discharged after passing by the burr removing part, the gas is forcibly drawn by a gas drawing member 40 (drawing system), which is connected to the opening of the hole 2 on an outer surface of the workpiece W. In FIG. 7, the gas drawing member 40 includes a drawing pump 41, an adapter 42, a pipe 43 and a filter 44. The pipe 43 is connected to the workpiece W by the adapter 42. The workpiece W, the filter 44 and the drawing pump 41 are connected with each other in this order by the pipe 43. In a case where a hole 45 is horizontally connected to the hole 1 inside the workpiece W, an opening of the hole 45 on the outer surface of the workpiece W is closed by a cap 46.

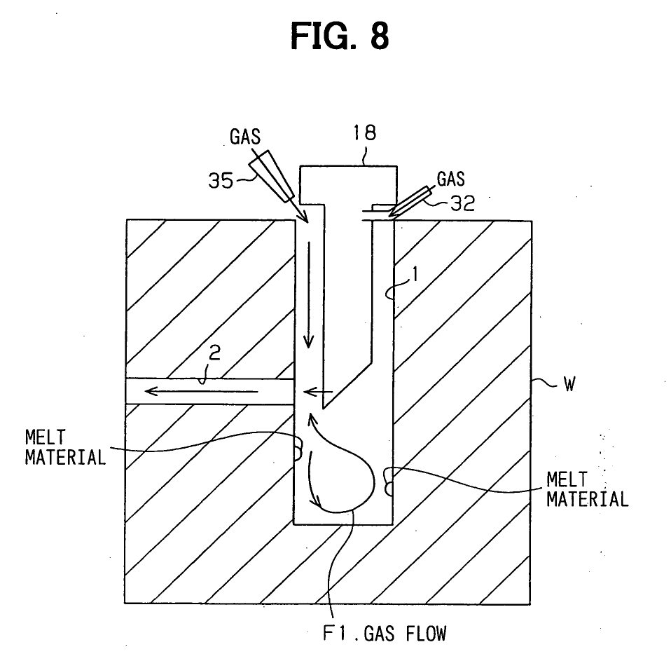

The reason of conducting the above described method will be described. When the gas is supplied into the hole 1 appropreately from the nozzle 35 and the gas inlet tube 32, it is possible to prevent the melt material from adhering to inside, because the hole 1 with the diameter of 10 mm is formed strait and the hole 1 has nothing to obstruct the gas flow. However, the deposit is likely to adhere in a case, where the hole 1 is formed long in the workpiece W and one end of the hole 1 is closed as shown in FIG. 8, because a gas flow F1 tend to stay in the hole 1 below the connection between the hole 1 and the hole 2. As shown in FIG. 7, the gas drawing member 40 is connected to the opening of the hole 2, which has the diameter of 3 mm, on the outer surface of the workpiece W through the drawing adapter 42. Then, the gas, which is supplied by the gas supplying nozzle 35, and the gas, which is discharged from the optical unit 18, is drawn by the gas drawing member 40. Then, the gas flow is prevented from staying in the hole 1 below the connection between the hole 1 and the hole 2, so that the deposit is prevented from adhering to inside the workpiece W. Further, a drawing effect is prevented from deteriorating by closing the hole 45, which is formed to extend horizontally.

Likewise, in order to prevent the deposit from adhering to the inside of the workpiece W, the gas is drawn from one of the hole 1 and the hole 2, which does not receive the optical unit 18, so that the gas passes by the burr 3 and discharges from the workpiece W. Therefore, the melt and sublimated material, which is generated while removing the burr, is prevented from adhering to the workpiece W. At the same time, the deposit is likely to be prevented from adhering to the reflecting mirror 14. Drawing the gas from the opening of the hole 1 (, which receives the optical unit 18), instead of the opening of the hole 2, is not desirable, because the melt and sublimated material, which is generated while removing the burr, is likely to adhere to the optical unit 18.

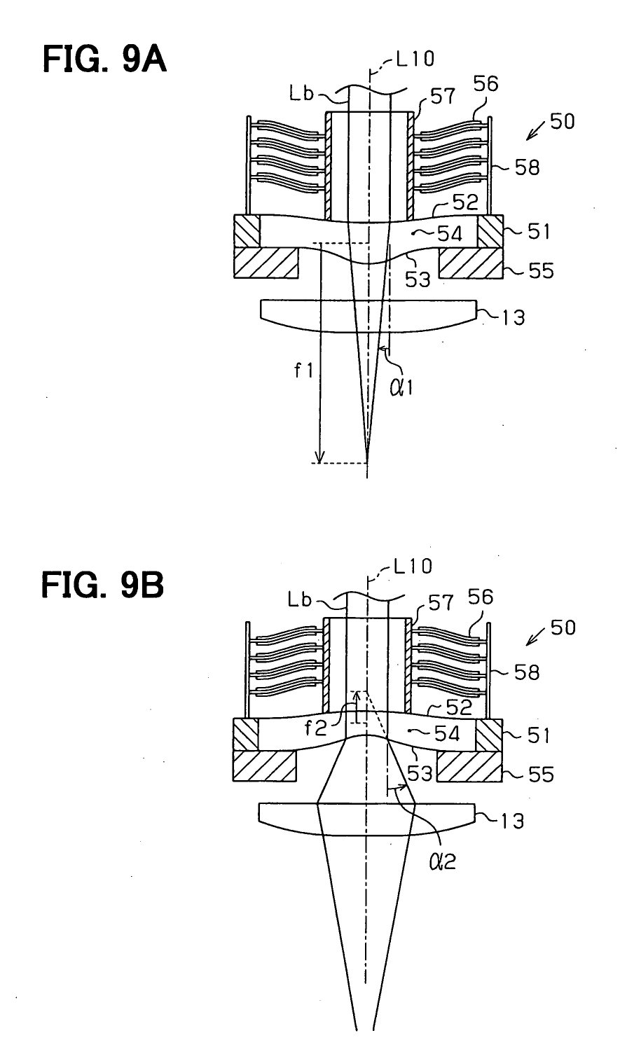

The beam diameter is adjusted by the vertical movement of the converging lens 13, which is moved by the sliding mechanism 27 and the motor 28 as shown in FIG. 4. As shown in FIGS. 9A and 9B, an adjustable focal point device 50 is installed on an incident side of the converging lens 13. By changing the focal length of the adjustable focal point device 50 within the range of f1 to f2 as shown in FIGS. 9A and 9B, angles of rays of the laser beam Lb on the incident side of the converging lens 13 with respect to an optical axis of the laser beam Lb is changed within a range of a convergence angle of α1 and a divergence angle of α2 respectively as shown in FIGS. 9A and 9B. Thus, by changing the angles of rays of the laser beam Lb on the incident side of the converging lens 13, the beam diameter is adjusted alternatively.

Specifically, the adjustable focal point device 50 includes a first ring part 51, a first glass transparent elastic plate 52 and a second glass transparent elastic plate 53, a working fluid 54, a second ring part 55, four piezoelectric bimorphs 56, a tubular inner surface connector 57 and rodlike outer surface connectors 58. The first glass transparent elastic plate 52 and second glass transparent elastic plate 53 adhere to both sides of the first ring part 51. The working fluid 54 is sealed in a space formed by the first ring part 51, the first glass transparent elastic plate 52 and second glass transparent elastic plate 53. The second ring part 55 is attached to the second glass transparent elastic plate 53. The tubular inner surface connector 57 is jointed with inner surfaces of four piezoelectric bimorphs 56. A bottom end along a longitudinal axis of the tubular inner surface connector 57 is jointed with the first glass transparent elastic plate 52. The rodlike outer surface connectors 58 are jointed with outer surfaces of the four piezoelectric bimorphs 56 and one bottom end of the rodlike outer surface connectors 58 are jointed with the first ring part 51. The rodlike outer surface connectors 58 are spaced evenly and arranged radially round the optical axis of the laser beam Lb. Silicon oil, which has a similar refractive index to refractive indexes of the first glass transparent elastic plate 52 and the second glass transparent elastic plate 53, is used as the working fluid 54. The first glass transparent elastic plate 52, the second glass transparent elastic plate 53 and the working fluid 54 form the adjustable lens. The piezoelectric bimorphs 56 are elastic plates, of which both sides are combined with ring piezoelectric plates. The elastic plates serve as common electrodes. A film-like electrode is formed on a surface of each ring piezoelectric plate. One of the surface electrodes of the each ring piezoelectric plates is electrically connected with the inner surface connector 57. The other of the surface electrodes of the each ring piezoelectric plates is electrically connected with the outter surface connector 58.

When a voltage is applied to the piezoelectric bimorph 56 through the inner surface connector 57 and the outter surface connector 58A, a shape of the piezoelectric bimorph 56 is changed so that the inner surface connector 57 is positioned at a corresponding height to the applied voltage. For example, when the voltage is not applied to the piezoelectric bimorph 56, the inner surface connector 57 is located at a lowest position as shown in FIG. 9A. Thus, at the inside of the second ring part 55, the first glass transparent elastic plate 52 and the second glass transparent elastic plate 53 form a downward projection. In contrast, when a highest voltage is applied to the piezoelectric bimorph 56 through the inner surface connector 57 and the outter surface connector 58, the first glass transparent elastic plate 52 and the second glass transparent elastic plate 53 form an upward projection as shown in FIG. 9B. Likewise, the shapes of the first glass transparent elastic plate 52 and the second glass transparent elastic plate 53 are adjusted according to the voltage, which is applied to the piezoelectric bimorph 56 that serves as a beam diameter adjusting actuator. Thus, the focal length of the adjustable lens, which includes the working fluid 54, the first glass transparent elastic plate 52 and the second glass transparent elastic plate 53, is adjusted within the range of f1 to f2 as shown in FIGS. 9A and 9B. Therefore, the beam diameter is adjusted by adjusting the focal point of the laser beam Lb, which passes inside the second ring part 55.

The adjustable lens (52, 53, 54), of which a curvature of a curved surface is adjustable, is located on the laser beam Lb incident side of the converging lens 13. The beam diameter adjusting actuator 56 changes the curvature of the curved surface of the adjustable lens (52, 53, 54). By changing angles of rays of the laser beam Lb on the incident side of the converging lens 13 with respect to the optical axis of the laser beam Lb within the rage of the convergence angle of α1 to the divergence angle of α2 in the drawings, the beam diameter at the irradiated spot is adjusted. The adjustable lens, of which the curvature of the curved surface is changeable, is used so that the curvature of the adjustable lens is changed while the position of the converging lens is fixed. This method is effective in a such problematic case, where the motor 28 produces a vibration while adjusting the beam diameter, in such a case where a linearity of a movement of the converging lens 13 becomes worse while the converging lens 13 moves along the optical axis of the laser beam Lb, and in such a case where the focal point needs to be shifted faster than a movement driven by the motor 28.

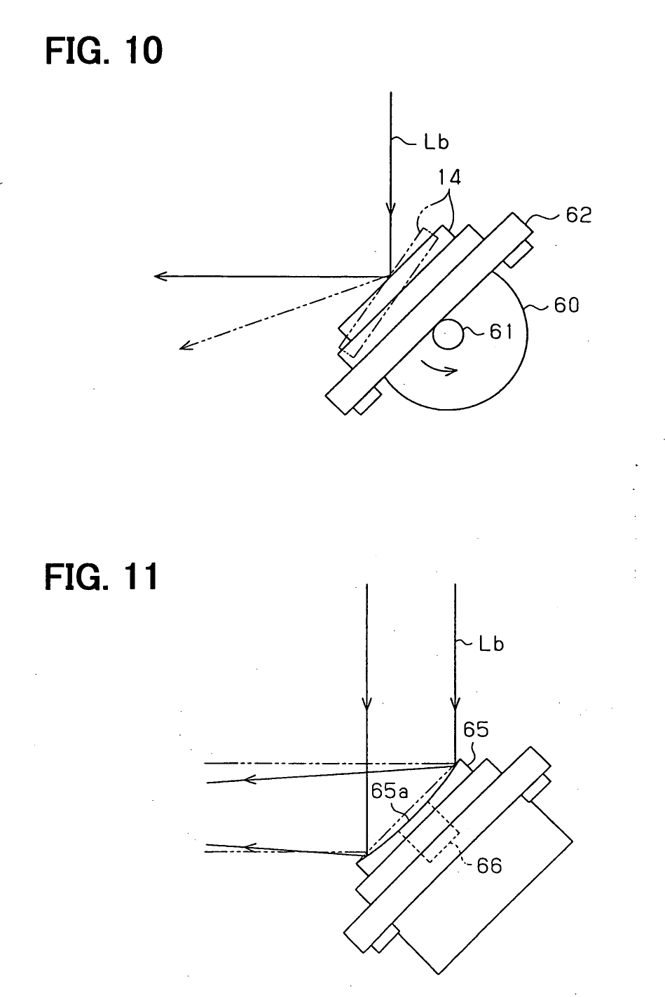

An orientation of the reflecting mirror 14 is adjusted by the screws 30 in FIG. 4. Instead, a structure of the reflecting mirror 14 in FIG. 10 is also applicable. As shown in FIG. 10, a rotatable plate 62 is equipped with an axis 61 of rotation. The rotatable plate 62 is rotatable around the axis 61 of rotation. The reflecting mirror 14 is fixed firmly to the rotatable plate 62. Thus, the reflecting mirror 14 is held in a way the orientation of the reflecting mirror 14 is adjustable. The axis 61 of rotation is connected with a motor 60, which drives the axis 61 of rotation. The laser beam Lb is steered by changing the orientation of the reflecting mirror 14, of which the orientation is changed by the motor 60. Likewise, the laser beam Lb is alternatively steered along the surface of the burr 3 as shown in FIG. 5A and 5B by changing the orientation of the reflecting mirror 14, of which the orientation is changed by the motor 60 that serves as an actuator.

FIG. 11 shows an alternative structure for the beam diameter adjusting mechanism. In FIG. 11, a concave mirror is used for a reflecting mirror 65. A reflecting surface 65a includes a sheet metal, which is equipped with a piezoelectric element 66 (e.g., PZT) on a backside. The sheet metal, which composes the reflecting surface, is deformed to have a desired curvature by adjusting an applied voltage to the piezoelectric element 66 (e.g., PZT) that serves as an actuator. Likewise, the beam diameter at the laser beam irradiated spot can be adjusted by changing the curvature of the reflecting surface of the reflecting mirror 65, which is designed so that the curvature of the reflecting surface is changeable. Although the reflecting mirror 65 is the concave mirror in this embodiment, a convex mirror, of which a curvature of a reflecting surface is adjustable, can be alternatively used.

In FIG. 1 and the like, the laser beam Lb, which is converged by the converging lens 13, is reflected by the reflecting mirror 14 toward the burr 3 through a bigger hole of the hole 1 and the hole 2, which intersects with each other. However, the converged laser beam Lb can be applied to the burr 3 alternatively through a smaller hole of the hole 1 and the hole 2, which intersects with each other, if a diameter of the smaller hole is bigger than a diameter of the tubular housing 26.

### Second Embodiment

The second embodiment of the present invention will be described mainly focusing on a difference between the first embodiment and the second embodiment.

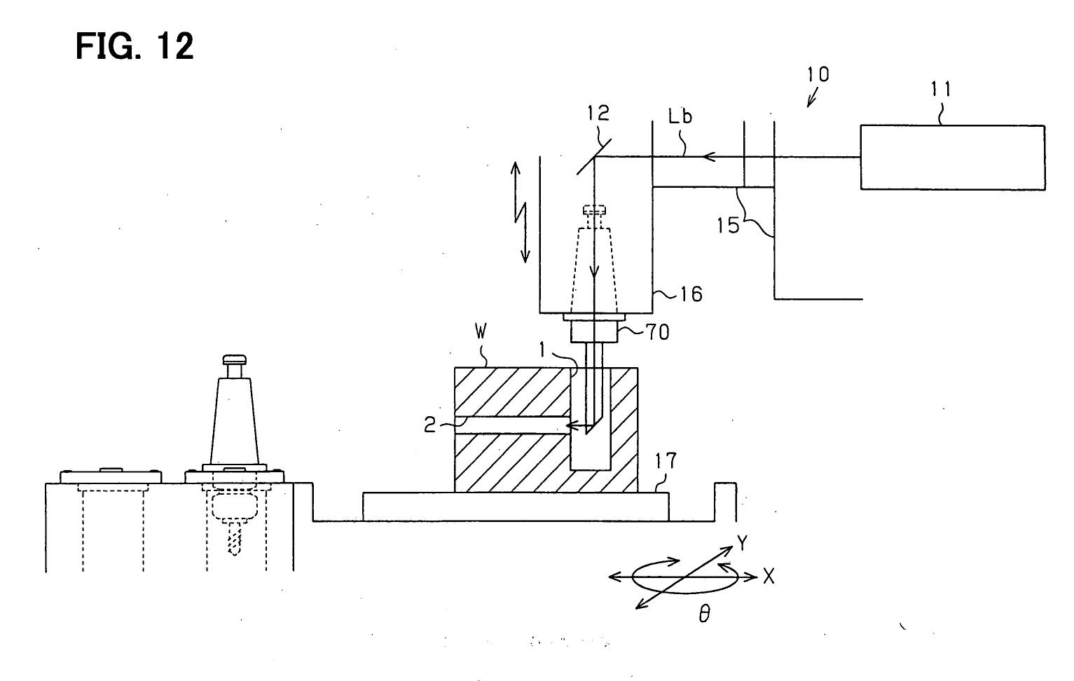

FIG. 12 is a schematic diagram showing a burr removing device according to the present embodiment.

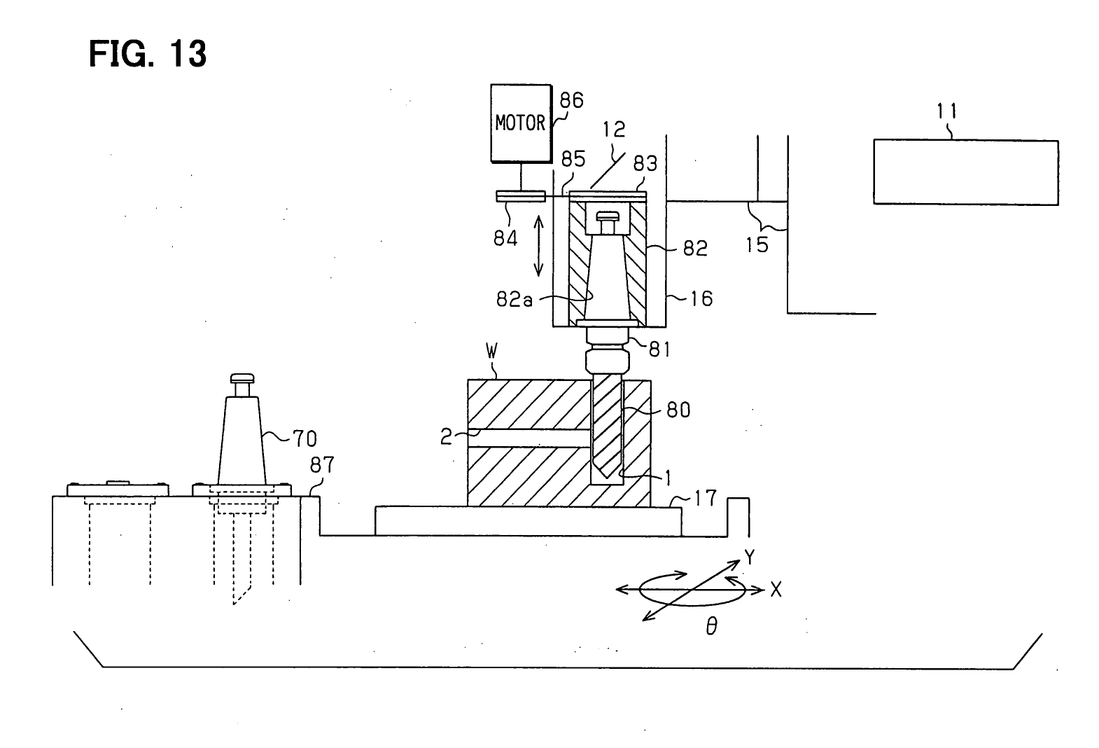

As showing in FIG. 13, the burr removing device according to the present embodiment includes a tool holder 81, which holds a drill 80 that serves as a cutting device. As shown in FIG. 12, the optical unit 70, which serves as an attachment, is automatically attached to the burr removing device, after the tool holder is automatically detached from the burr removing device. At time when the drilling process is over, the burr removing device removes the burr by use of a position adjusting function, which is equipped to the cutting device. More than one optical unit 70 are prepared as the attachments and are automatically replaced with each other. The burr removing device needs to deal with various conditions, such as a diameter of a hole, which is cut in a part (workpiece W), an angle of the hole relative to the workpiece W, and forms of the burr. Also, the burr removing device needs to deal with a complex burr removing process of the various conditions of the burr 3, such as a size and a shape, due to a complex connection of the hole 1 and the hole 2. Therefore, the burr removing device has an optical tool replacing function, which automatically replaces more than one optical unit 70.

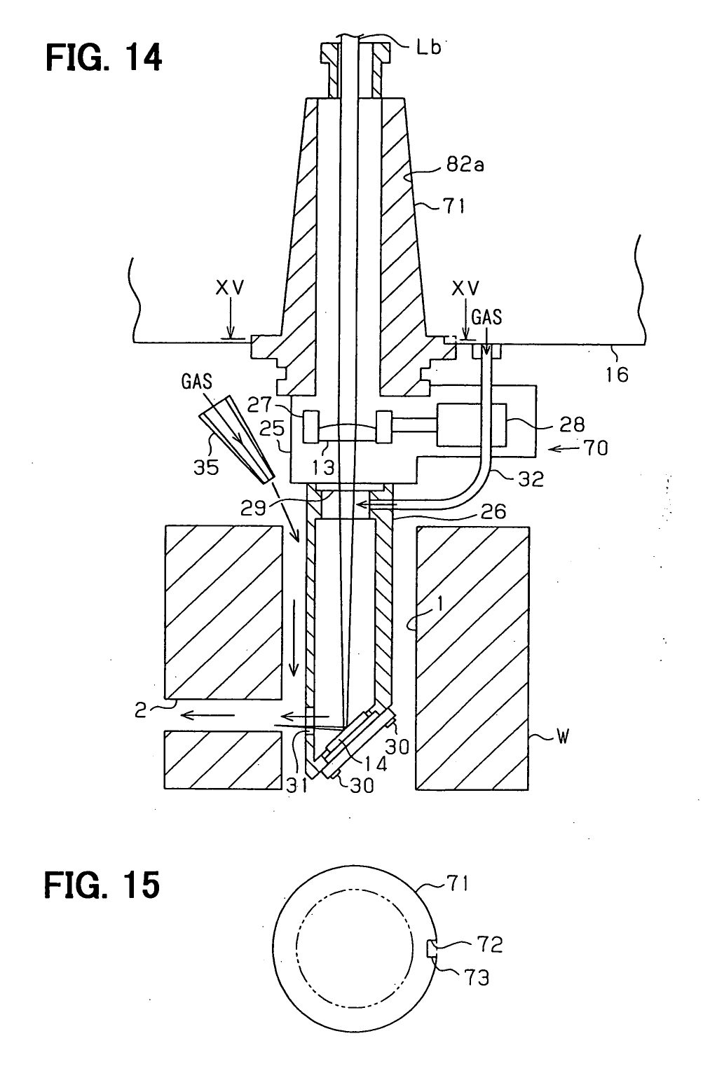

FIG. 14 shows a view of a main part of an alternative burr removing device for FIG. 4 according to the second embodiment.

Inner components of the optical unit 70 include the converging lens 13, a protecting glass 29, the reflecting mirror 14 and the like. Thus, the optical unit 70 has a similar structure to the optical unit 18 as described in the first embodiment.

In FIG. 13, a vertical positioning member 16 is equipped with a rotating housing 82. The rotating housing has an hole 82a, into which the tool holder 81 is fitted. The tool holder 81 holds the drill 80, which serves as the cutting tool. The rotating housing 82 is connected with a motor 86 through a pair of pulleys 83, 84 and a belt 85. The motor 86 drives to rotate the rotating housing 82 and the rotation of the rotating housing 82 rotates the tool holder 81 (the drill 80) to cut holes.

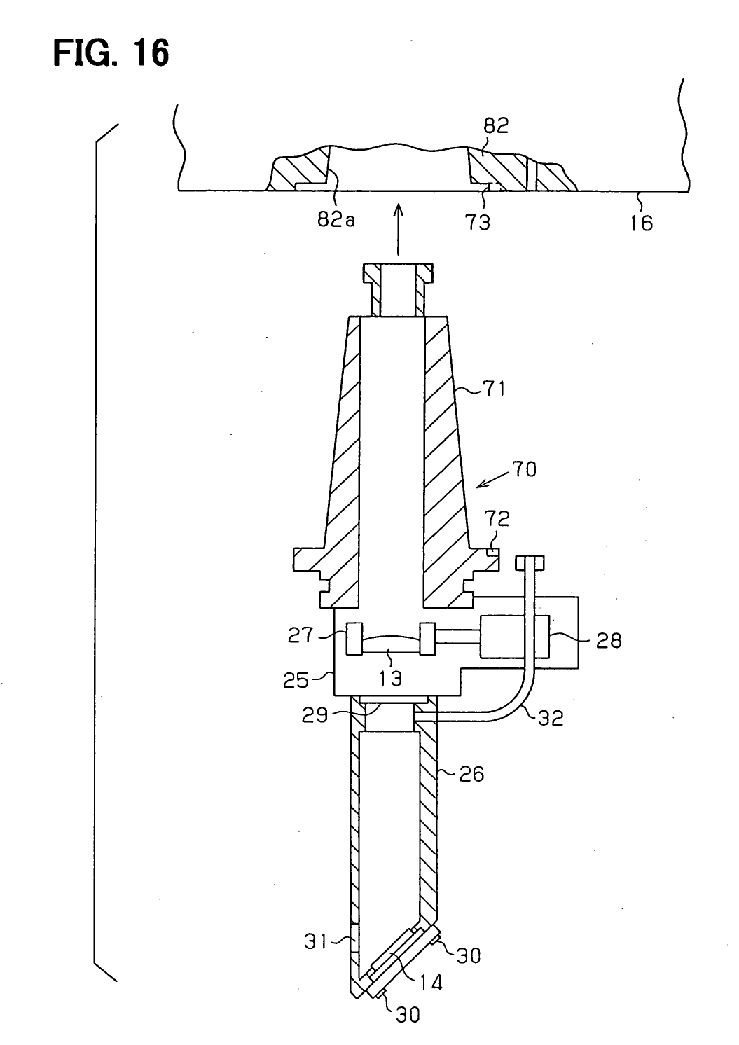

As shown in FIG. 16, an upper housing 71 of the optical unit 70 takes a form (a cone shape), so that the optical unit 70 is fitted into the hole 82a. A rim of the upper housing 71 has a key channel 72, which serves as a projection-recess positioning member, as shown in FIG. 15 (a view taken along line XV-XV in FIG. 14). The key channel 72 of the upper housing 71 is engaged in a key projection 73 of the rotating housing 82. Thus, at time when the upper housing 71 of the optical unit 70 is fitted into the hole 82a of the rotating housing 82, by engaging the key channel 72 with the key projection 73, the optical unit 70 can be positioned accurately.

Likewise, in order to position the optical unit 70 relative to the vertical positioning member 16, which serves as a device main body (or, an attachment body) through setting an irradiating direction of the laser beam Lb, a steering direction of the laser beam Lb and an inserting orientation of the tubular housing 26 relative to the hole 1, the key channel 72 on the optical unit 70 and the projection 73 on a holder (the vertical positioning member 16), which holds the optical unit 70, are provided. The optical unit 70 is positioned relative to the device main body 16 by the engagement of the projection with the recess. Therefore, the optical unit 70 is positioned properly relative to the device main body 16.

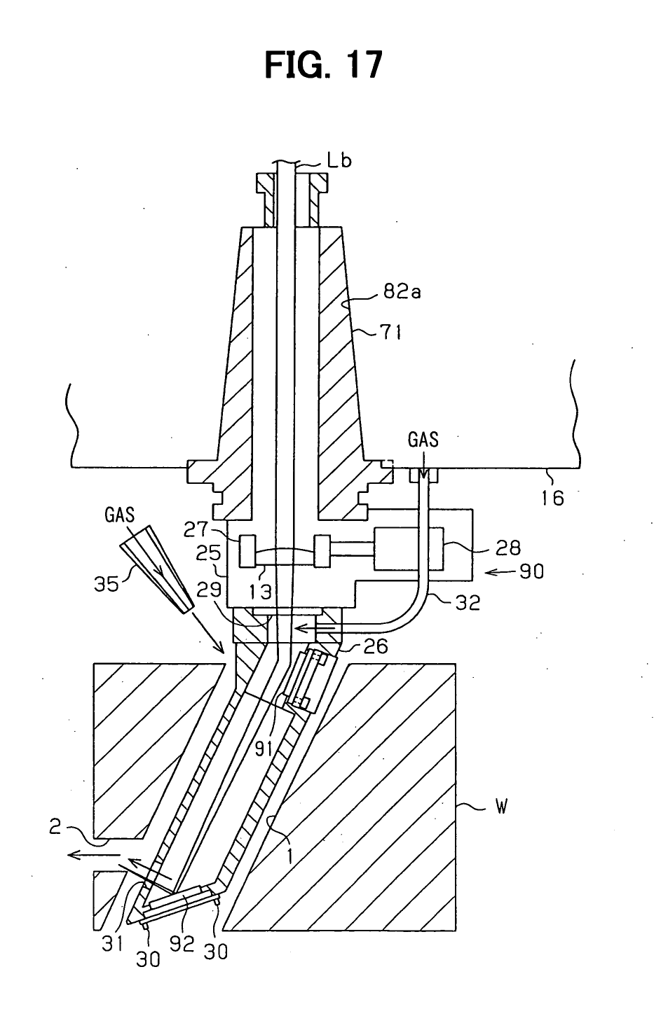

FIG. 17 is an optical unit 90 as the attachment. The optical unit 90 is used in a case when the longitudinal axis of the hole 1 is formed with a tilt relative to a surface of the workpiece W. Specifically, the optical unit 90 has at least two reflecting mirror 91, 92 located inside of the optical unit 90. The longitudinal axis of the tubular housing 26 of the optical unit 90 is angled relative to the optical axis of the laser beam Lb, which travels toward the converging lens 13. The optical axis of the laser beam Lb, which has passed through the converging lens 13, is made parallel to the longitudinal axis of the tubular housing 26 by at least one of the at least two reflecting mirror 91, 92. Thus, inside of the tubular housing 26 of the optical unit 90, the axis of the laser beam Lb, which has passed through the converging lens 13, is made parallel to the longitudinal axis of the hole 1 by the at least one of the at least two reflecting mirror 91, 92. Likewise, the longitudinal axis of the hole 1 is parallel to the longitudinal axis of the tubular housing 26, so that the tubular housing 26 is inserted into the hole 1. Screws 30 adjusts a position of the irradiated spot, which is irradiated by the laser beam Lb.

The burr removing device needs to deal with various conditions, such as a diameter of a hole, which is cut in a part (workpiece W), an angle of the longitudinal axis of the hole relative to the workpiece W and forms of the burr 3. Also, the burr removing device needs to deal with a complex burr removing process of various conditions of the burr 3, such as sizes and shapes, due to a complex way of connection of the hole 1 and the hole 2. Thus, the burr removing device is prepared with the optical units 70, 90, which are suited with the various conditions. Each of the optical unit 70 and the optical unit 90 is set on a rack 87, which is movable with a table 17 in the X-axis, Y-axis and θ directions, as shown in FIG. 13.

Away of replacing the optical unit 70 and the optical unit 90 with each other according to conditions will be described. The optical unit 70 (90) or the tool holder 81 is detached from the hole 82a of the vertical positioning member 16. Then, the optical unit 70 (90), which is set on the rack 87, is moved to vertically face the vertical positioning member 16, through the positioning mechanism for moving in the X-axis, Y-axis and θ directions of the table 17 and the rack 87 as shown in FIG. 13. Then, the vertical positioning member 16 is shifted downward by the vertical positioning mechanism of the vertical positioning member 16, so that a selected optical unit 70 (90) is inserted into the hole 82a of the vertical positioning member 16. At this time, the selected optical unit 70 (90) is positioned by engaging the key channel 72 with the key projection 73. Therefore, the irradiating direction of the laser beam Lb inside of the selected optical unit 70 (90), the steering direction of the laser beam Lb inside of the selected optical unit 70 (90) and the inserting orientation of the tubular housing 26 relative to the hole 1 are determined. Then the workpiece W is positioned to vertically face the vertical positioning member 16 (the selected optical unit 70 (90)).

Then, the burr 3 is removed by guiding the laser beam Lb toward a target spot, through positioning the selected optical unit 70 (90) in the hole 1. Further, the burr 3 is removed by steering the laser beam Lb (e.g., the rotation in the θ direction of the workpiece W or the optical unit 70 (90)) as described above.

Likewise, the hole cutting process and the burr removing process are operated by replacing the optical units 70 (90), which are prepared according to a size and a form of the hole 1. Therefore, the burr 3, which is formed at various parts of various kinds of products, can be removed. For example, as shown in FIG. 17, in a case when the burr 3 that is formed in the hole 1 that has the tilt relative to the workpiece W, the tubular housing 26 can be inserted into the hole 1 by making the longitudinal axis of the tubular housing 26 parallel to the longitudinal axis of the hole 1.

The rotating housing 82, into which the tool holder 81 of the cutting device is fitted, can be used to hold the optical unit 70. Thus, one device can perform both the process of cutting holes and the process of removing burr that is formed during the process of cutting holes. And an expensive device for applying the high-density energy beam is effectively used. The process of cutting holes is performed by rotating the tool holder 81, which holds the drill 80. After the process of cutting holes is finished, the tool holder 81 is replaced with the optical unit 70 and the burr removing process is performed so that the burr 3, which is formed at the connection between the hole 1 and the hole 2 inside the workpiece W, is removed. Thus, inexpensive and highly efficient processes are performed.

Thus, features of the second embodiment will be described. The optical unit 70 at least includes the tubular housing 26, which is integrated together with the reflecting mirror 14. Because the optical unit 70 is detachably connected to the device main body 16, by attaching an optimal optical unit 70 for conditions of the workpiece W, the burr removing process can be operated on various kinds of workpieces (parts). Also, the optical unit 70 serves as a replaceable attachment with the tool holder 81, which holds the drill 80 (the cutting tool). Therefore, in order to make effective use of the expensive device, after the process of cutting holes with the drill 80 is finished, the tool holder 81 can be replaced with the optical unit 70. Then, the burr 3, which is formed in the hole 1 inside the workpiece W, can be removed.

An application of the second embodiment of the present invention will be described.

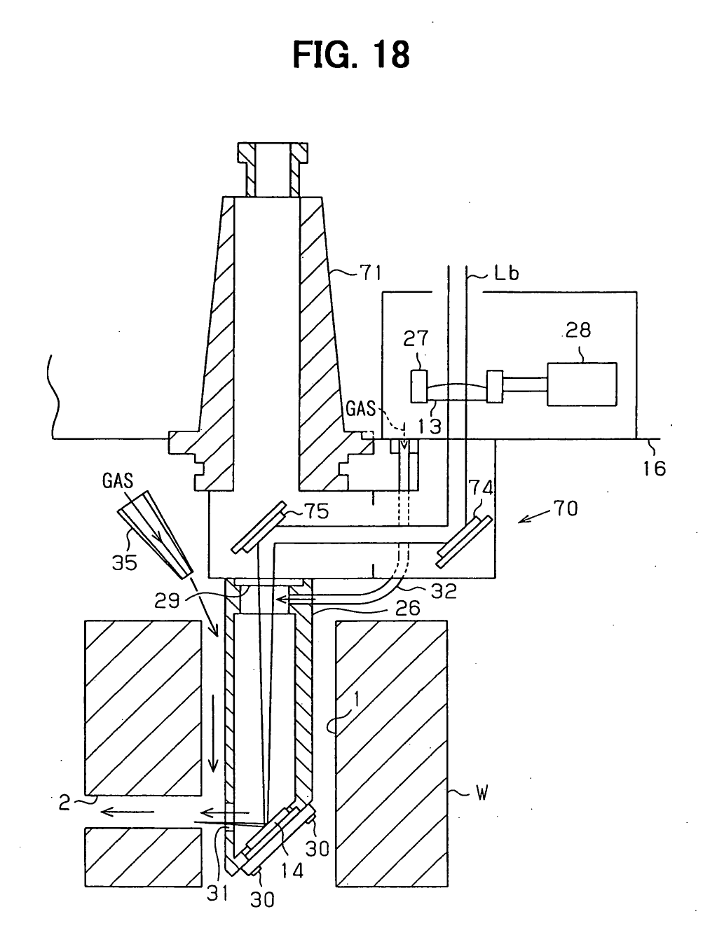

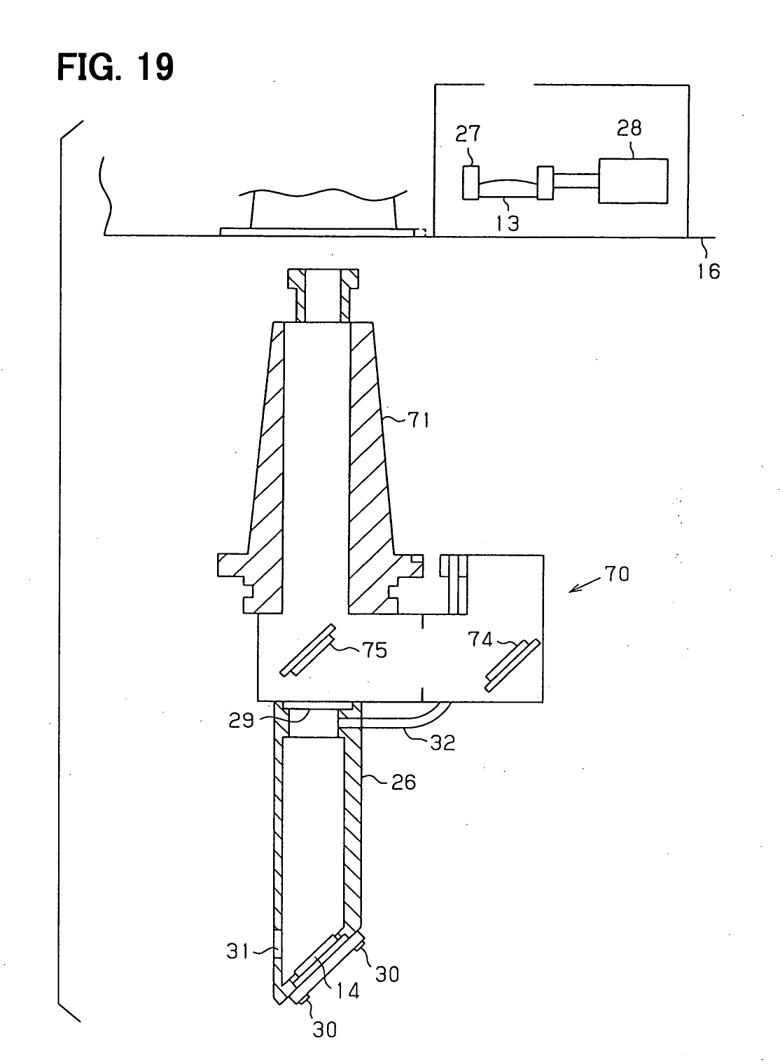

The optical unit 70, as shown in FIG. 16, is equipped with the sliding mechanism 27 and the motor 28 inside the optical housing 25. Therefore, in a case where the burr removing device is equipped with a hole cutting function, the sliding mechanism 27 and the motor 28 can be prevented from getting damaged by a vibration of the rotating housing 82 while the rotating housing 25 is rotating. However, the sliding mechanism 27 and the motor 28 are not necessarily contained inside the replaceable optical unit 70. As shown in FIG. 19, the converging lens 13, the sliding mechanism 27 and the motor 28 can be located in the vertical positioning member 16, which serves as the device main body. Also, two mirrors 74, 75 are added and located inside of the optical unit 70. Therefore, as shown in FIG. 18, the laser beam Lb, which passes through the converging lens 13, is reflected by the two reflecting mirrors 74, 75 inside of the optical unit 70, so that the laser beam Lb is guided into the tubular housing 26.

In the description above, the high-density energy beam is the laser beam. However, a lamp radiation beam, an electron beam and the like are alternatively used. Note that the laser beam is convenient, because the laser beam is easy to handle with and a laser is widespread as a general device.

Additional advantages and modifications will readily occur to those skilled in the art. The invention in its broader terms is therefore not limited to the specific details, representative apparatus, and illustrative examples shown and described.

What is claimed is:

1. A method for removing a burr, which is formed at a connection between a first hole and a second hole that are angled relative to each other inside a workpiece, the method comprising:
generating a high-density energy beam;
converging the high-density energy beam by a converging lens, which is located outside of the first and second holes of the workpiece; and
reflecting the converged high-density energy beam toward the burr by at least one reflecting mirror, which is located in one of the first and second holes.

2. The method according to claim 1, further comprising adjusting a diameter of the high-density energy beam at a spot where the burr is located by changing a distance between the converging lens and the at least one reflecting mirror.

3. The method according to claim 1, further comprising adjusting a diameter of the high-density energy beam at a spot where the burr is located by changing angles of rays of the high-density energy beam on an incident side of the converging lens with respect to an optical axis of the high-density energy beam.

4. The method according to claim 1, further comprising adjusting a diameter of the high-density energy beam at a spot where the burr is located by changing a curvature of a reflecting surface of one of the at least one reflecting mirror.

5. The method according to claim 1, further comprising passing gas near the burr by supplying gas into the one of the first and second holes, where the at least one reflecting mirror is located, at time of removing the burr by applying the high-density energy beam.

6. The method according to claim 1, further comprising passing gas near the reflecting surface of the at least one reflecting mirror by supplying gas into the one of the first and second holes, where the at least one reflecting mirror is located, at time of removing the burr by applying the high-density energy beam.

7. The method according to claim 5, further comprising forcibly drawing the gas from the other one of the first and second holes.

8. The method according to claim 1, further comprising steering the high-density energy beam over the burr to apply the high-density energy beam to the burr, which is formed at an edge of the connection between the first hole and the second hole.

9. The method according to claim 1, further comprising steering the high-density energy beam over the burr by changing an orientation of at least one of the at least one reflecting mirror.

10. The method according to claim 1, further comprising irradiating the whole burr, which is formed at an edge of the connection between the first hole and the second hole with the high-density energy beam by making the diameter of the high-density energy beam larger than a diameter of the other one of the first and second holes.

11. The method according to claim 1, further comprising monitoring an interior of the first hole and the second hole by branching off an optical path as a monitor optical path on an incident side of the at least one reflecting mirror.

12. The method according to claim 1, wherein the high-density energy beam is a laser beam.

13. A burr removing device for removing a burr, which is formed at a connection between a first hole and a second hole that are angled relative to each other inside a workpiece, the burr removing device comprising:
a high-density energy beam generator for generating a high-density energy beam;
a tubular housing, which is located in one of the first and second holes at time of operation;
a converging lens located outside of the workpiece for converging the high-density energy beam generated by the high-density energy beam generator; and
at least one reflecting mirror located inside the tubular housing for reflecting the high-density energy beam, which is converged by the converging lens, toward the burr.

14. The burr removing device according to claim 13, wherein a distance between the converging lens and one of the at least one reflecting mirror is longer than a distance between an inlet of the one of the first and second holes, which receives the tubular housing, and the connection of the first hole and the second hole.

15. The burr removing device according to claim 13, wherein:
the tubular housing and the at least one reflecting mirror are integrated together to form an optical unit; and
the burr removing device further comprises an attachment body, to which the optical unit is detachably attached.

16. The burr removing device according to claim 15, wherein the optical unit is detachable from the attachment body as a replacement to a tool holder that holds a cutting tool.

17. The device according to claim 15, wherein:
one of the optical unit and the attachment body includes at least one projection; and
the other one of the optical unit and the attachment body includes at least one recess, which is detachably engaged with the at least one projection to position the optical unit relative to the attachment body.

18. The burr removing device according to claim 15, wherein:
the at least one reflecting mirror includes at least two reflecting mirrors;
a longitudinal axis of the tubular housing of the optical unit is angled against an optical axis of the high-density energy beam that travels toward the converging lens; and
the optical axis of the high-density energy beam, which has passed through the converging lens, is made parallel to the longitudinal axis of the tubular housing and is guided toward the burr by at least one of the at least two reflecting mirrors.

19. The burr removing device according to claim 13, further comprising a beam diameter adjustment mechanism, which holds and moves the converging lens toward and away from the at least one reflecting mirror along the optical axis of the high-density energy beam.

20. The burr removing device according to claim 13, further comprising:
an adjustable lens, of which a curvature of a curved surface is adjustable and which is located on an incident side of the converging lens; and
a beam diameter adjusting actuator, which changes the curvature of the curved surface of the adjustable lens.

21. The burr removing device according to claim 13, further comprising an adjusting device, which adjusts a curvature of a reflecting surface of one of the at least one reflecting mirror.

22. The burr removing device according to claim 13, further comprising an actuator that drives one of the at least one reflecting mirror to change an orientation of the one of the at least one reflecting mirror.

23. The burr removing device according to claim 13, wherein:
the tubular housing includes a gas inlet and a gas outlet;
the burr removing device further comprises a gas supplier for supplying gas to the gas inlet of the tubular housing so that the gas flows through the tubular housing and is discharged from the gas outlet of the tubular housing;
the gas outlet of the tubular housing serves as a laser beam outlet of the tubular housing, through which the high-density energy beam is outputted from the tubular housing toward the burr; and
the at least one reflecting mirror is positioned between the gas inlet and the gas outlet in the tubular housing.

24. The burr removing device according to claim 13, further comprising a gas supplier for supplying gas to the burr through a space between an outer surface of the tubular housing and an inner wall of the one of the first and second holes, which receives the tubular housing.

25. The burr removing device according to claim 23, further comprising a gas drawing member, which is connected to an opening that is opposite from the connection and that is provided on the other one of the first and second holes, in order to forcibly draw the gas through the other one of the first and second holes.

26. The burr removing device according to claim 13, further comprising:
a beam splitter, which is located between the high-density energy beam generator and one of the at least one reflecting mirror; and
a camera, which monitors an interior of the first and second holes through the beam splitter.

27. The burr removing device according to claim 13, wherein the high-density energy beam, which is generated by the high-density energy beam generator, is a laser beam.
